(19) United States
(12) Patent Application Publication
(10) Pub. No.: US 2011/0170474 A1
(43) Pub. Date: Jul. 14, 2011

(54) METHOD AND APPARATUS FOR TRANSPARENT RELAY HYBRID AUTOMATIC REPEAT REQUEST (HARQ)

(76) Inventors: Tingfang JI, San Diego, CA (US); Aamod D. KHANDEKAR, San Diego, CA (US); Naga BHUSHAN, San Diego, CA (US)

(21) Appl. No.: 12/836,464

(22) Filed: Jul. 14, 2010

Related U.S. Application Data
(60) Provisional application No. 61/225,844, filed on Jul. 15, 2009.

(51) Int. Cl. H04B 7/14

(52) U.S. Cl. 370/315

(57) ABSTRACT

Systems, apparatuses, and methods are disclosed for a relay station for use in a communication system with a base station and user equipment (UE). The relay station may decode and forward a data packet between the base station and the UE that the relay station services in which the relay station does not establish a direct link with the UE. Further, the relay station indicates successful decoding of the data packet to the base station such that if the base station receives information indicating successful decoding of the data packet from the relay station, the base station terminates a HARQ transmission on a direct link between the base station and the UE such that HARQ retransmission time is extended compared to direct communications between the base station and the UE.

### CROSS-REFERENCE TO RELATED APPLICATIONS

This application claims the benefit pursuant to 35 U.S.C. 119(e) of U.S. Provisional Application No. 61/225,844, filed Jul. 15, 2009, which application is specifically incorporated herein, in its entirety, by reference.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

To supplement conventional mobile phone network base stations, additional base stations may be deployed to provide more robust wireless coverage to mobile units. For example, wireless relay stations and small-coverage base stations (e.g., commonly referred to as access point base stations, Home NodeBs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a block diagram of a communication system;

FIG. 3 illustrates an exemplary communication system to enable deployment of access point base stations within a network environment;

FIG. 4 illustrates a wireless communication system, which may be an LTE system or some other wireless system that utilizes a relay station;

FIG. 5 illustrates a block diagram of a design of base station/eNB, relay station, and UE;

FIG. 6 illustrates a block diagram for a methodology for applying HARQ procedures for transparent relays for a relay station;

FIG. 7 is a flowchart that illustrates a process for applying HARQ procedures for transparent relays for a relay station;

FIG. 8 illustrates a block diagram for a methodology in which for each UL transmission, the anchor base station may schedule two transmissions, one for a UE and another for a relay station;

FIG. 9 illustrates a block diagram of a methodology for applying asynchronous HARQ procedures for a downlink (DL); and

FIG. 10 is a flowchart that illustrates a process for applying HARQ procedures for a downlink (DL).

### DESCRIPTION

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

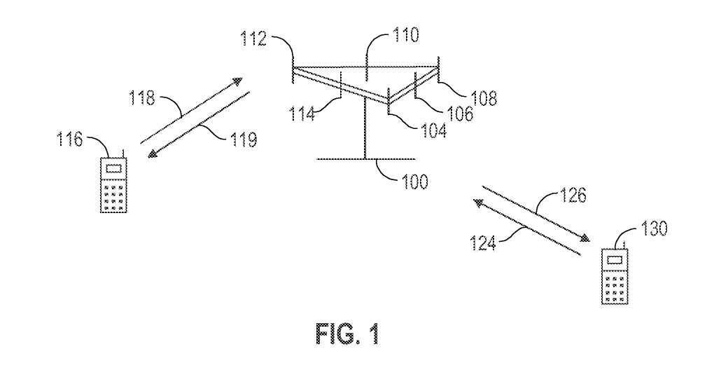

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 119 and receive information from access terminal 116 over reverse link 118. Access terminal 130 is in communication with antennas 106 and 108, where antennas 106 and 108 transmit information to access terminal 130 over forward link 126 and receive information from access terminal 130 over reverse link 124. In a FDD system, communication links 118, 119, 124 and 126 may use different frequency for communication. For example, forward link 119 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 119 and 126, the transmitting antennas of access point 100 utilize beamforming in order to improve the signal-to-noise ratio of forward links for the different access terminals 116 and 130. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, an evolved Node B (eNB), or some other terminology. An access terminal may also be called an access terminal, user equipment (UE), a wireless communication device, terminal, access terminal or some other terminology.

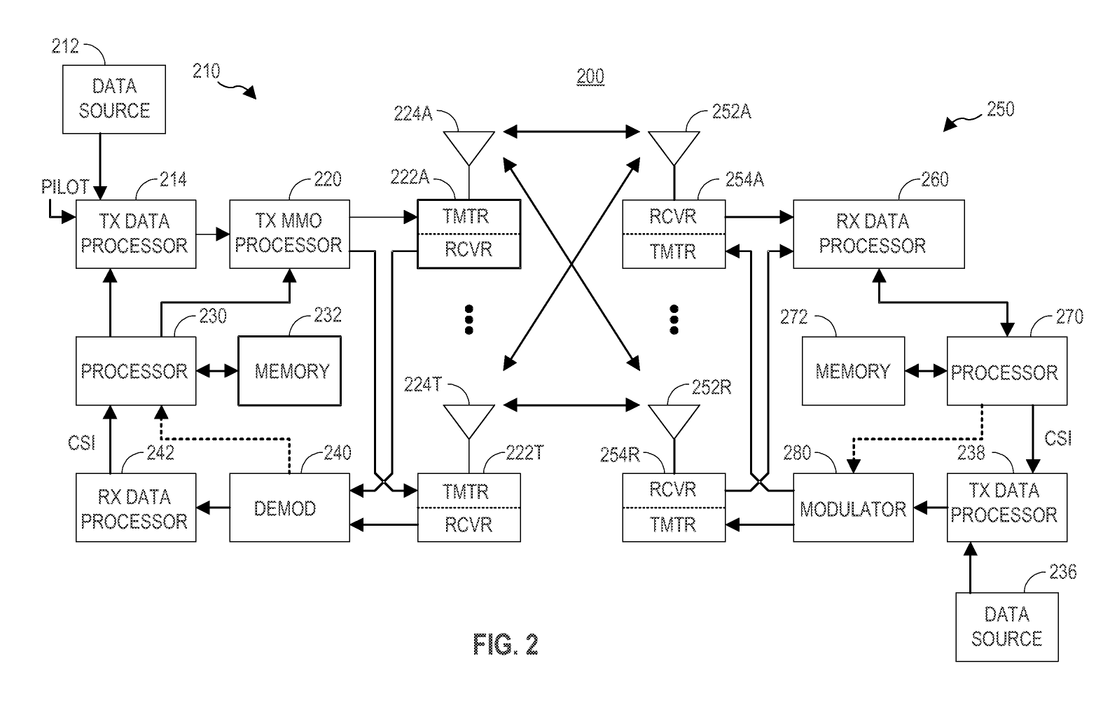

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

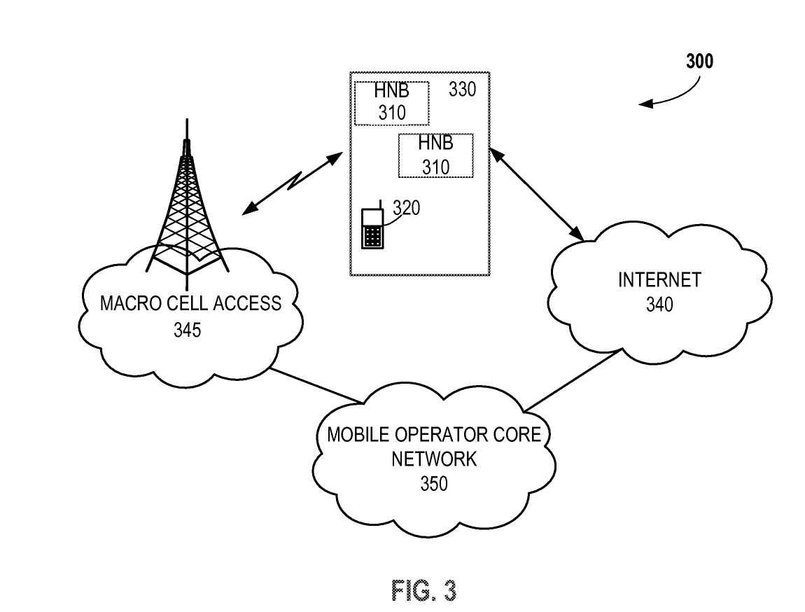

FIG. 3 illustrates an exemplary communication system to enable deployment of access point base stations within a network environment. As shown in FIG. 3, the system 300 includes multiple access point base stations or, in the alternative, femto cells, Home Node B units (HNBs), or Home evolved Node B units (HeNBs), such as, for example, HNBs 310, each being installed in a corresponding small scale network environment, such as, for example, in one or more user residences 330, and being configured to serve associated, as well as alien, user equipment (UE) or mobile stations 320. Each HNB 310 is further coupled to the Internet 340 and a mobile operator core network 350 via a DSL router (not shown) or, alternatively, a cable modem (not shown), and macro cell access 345.

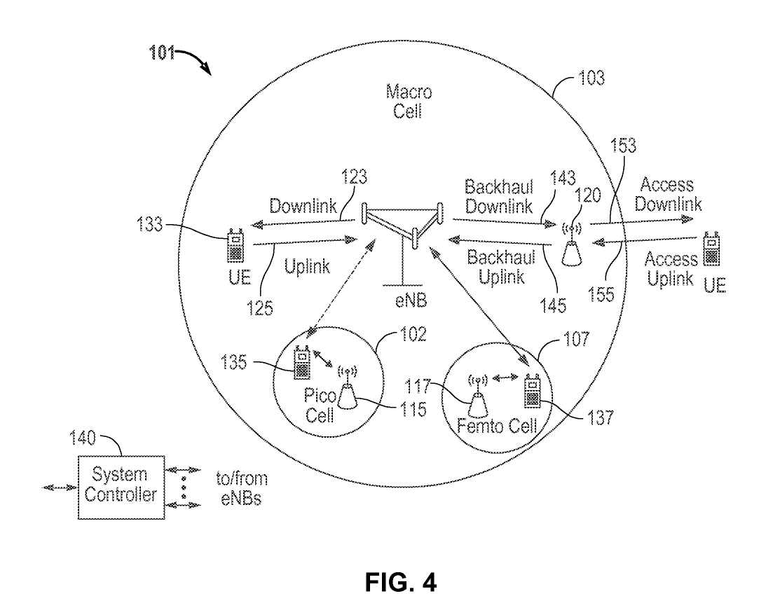

FIG. 4 shows a wireless communication system 101, which may be an LTE system or some other wireless system that utilizes a relay station. System 101 may include a number of evolved Node Bs (eNBs), relay stations, and other system entities that can support communication for a number of UEs. An eNB may be a station that communicates with the UEs and may also be referred to as a base station, a Node B, an access point, etc. An eNB may provide communication coverage for a particular geographic area. In 3GPP, the term “cell” can refer to a coverage area of an eNB and/or an eNB subsystem serving this coverage area, depending on the context in which the term is used. An eNB may support one or multiple (e.g., three) cells.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a femto eNB or a home eNB. In FIG. 4, an eNB 110 may be a macro eNB for a macro cell 103, an eNB 115 may be a pico eNB for a pico cell 105, and an eNB 117 may be a femto eNB for a femto cell 107. A system controller 140 may couple to a set of eNBs and may provide coordination and control for these eNBs.

A relay station 120 may be a station that receives a transmission of data and/or other information from an upstream station (e.g., eNB 110 or UE 130) and sends a transmission of the data and/or other information to a downstream station (e.g., UE 130 or eNB 110). A relay station may also be referred to as a relay, a relay eNB, etc. A relay station may also be a UE that relays transmissions for other UEs. In FIG. 4, relay station 120 may communicate with eNB 110 and UE 130 in order to facilitate communication between eNB 110 and UE 130.

UEs 130, 133, 135 and 137 may be dispersed throughout the system, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may communicate with eNBs and/or relay stations on the downlink and uplink. The downlink (or forward link) refers to the communication link from an eNB to a relay station or from an eNB or a relay station to a UE. The uplink (or reverse link) refers to the communication link from the UE to the eNB or relay station or from the relay station to the eNB. In FIG. 4, UE 133 may communicate with eNB 110 via a downlink 123 and an uplink 125. UE 130 may communicate with relay station 120 via an access downlink 153 and an access uplink 154. Relay station 120 may communicate with eNB 110 via a backhaul downlink 143 and a backhaul uplink 145.

In general, an eNB may communicate with any number of UEs and any number of relay stations. Similarly, a relay station may communicate with any number of eNBs and any number of UEs. For simplicity, much of the description below is for communication between eNB 110 and UE 130 via relay station 120.

LTE utilizes orthogonal frequency division multiplexing (OFDM) on the downlink and single-carrier frequency division multiplexing (SC-FDM) on the uplink. OFDM and SC-FDM partition a frequency range into multiple (N.sub.FFT) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N.sub.FFT) may be dependent on the system bandwidth. For example, N.sub.FFT may be equal to 128, 256, 512, 1024 or 2048 for system bandwidth of 1.25, 2.5, 5, 10 or 20 megahertz (MHz), respectively.

The system may utilize FDD or TDD. For FDD, the downlink and uplink are allocated separate frequency channels. Downlink transmissions and uplink transmissions may be sent concurrently on the two frequency channels. For TDD, the downlink and uplink share the same frequency channel. Downlink and uplink transmissions may be sent on the same frequency channel in different time intervals.

Thus, wireless communication system 101 may include one more base stations 110 that can support communication for a number of UEs 130, 132. 135, 137. The system may also include relay stations 120 that can improve the coverage and capacity of the system without the need for a potentially expensive wired backhaul link. A relay station may be a “decode and forward” station that may receive a signal from an upstream station (e.g., a base station), process the received signal to recover data sent in the signal, generate a relay signal based on the recovered data, and transmit the relay signal to a downstream station (e.g., a UE).

For example, relay station 120 may communicate with base station 110 on a backhaul link and may appear as a UE to the base station. The relay station may also communicate with one or more UEs on an access link and may appear as a base station to the UE(s). However, the relay station typically cannot transmit and receive at the same time on the same frequency channel. Hence, the backhaul and access links may be time division multiplexed. Furthermore, the system may have certain requirements that may impact the operation of the relay station. It may be desirable to support efficient operation of the relay station in light of its transmit/receive limitation as well as other system requirements.

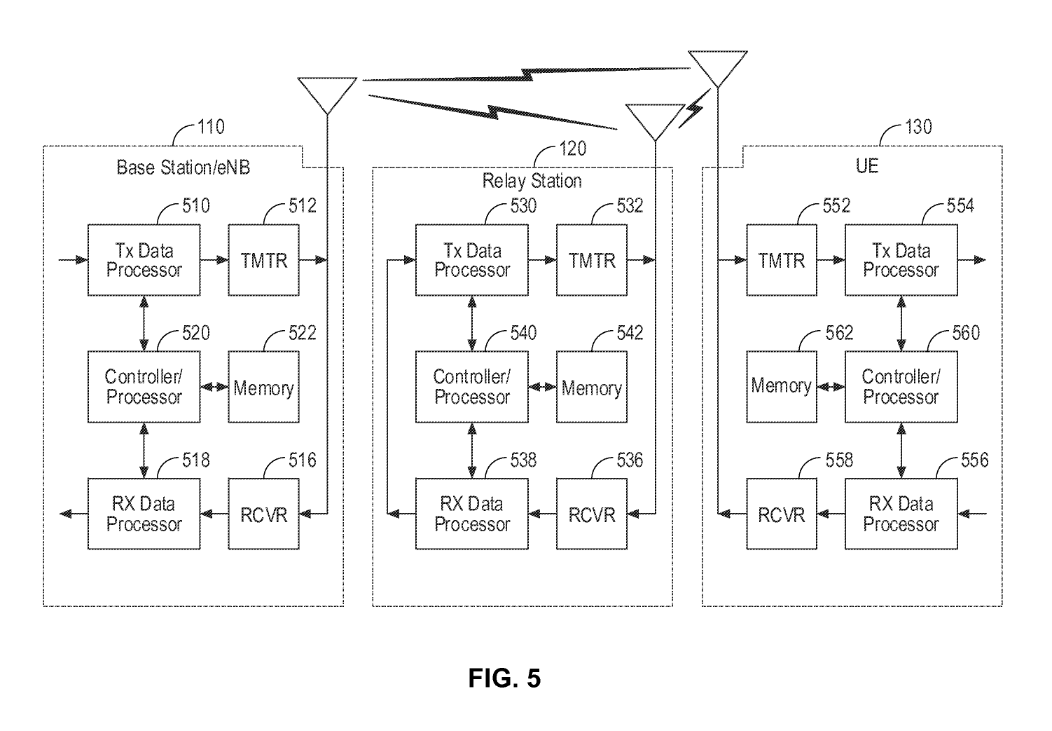

FIG. 5 shows a block diagram of a design of base station/eNB 110, relay station 120, and UE 130. Base station 110 may send transmissions to one or more UEs on the downlink and may also receive transmissions from one or more UEs on the uplink. For simplicity, processing for transmissions sent to and received from only UE 130 is described below.

At base station 110, a transmit (TX) data processor 510 may receive packets of data to send to UE 130 and other UEs and may process (e.g., encode and modulate) each packet in accordance with a selected MCS to obtain data symbols. For HARQ, processor 510 may generate multiple transmissions of each packet and may provide one transmission at a time. Processor 510 may also process control information to obtain control symbols, generate reference symbols for reference signal, and multiplex the data symbols, the control symbols, and reference symbols. Processor 510 may further process the multiplexed symbols (e.g., for OFDM, etc.) to generate output samples. A transmitter (TMTR) 512 may condition (e.g., convert to analog, amplify, filter, and upconvert) the output samples to generate a downlink signal, which may be transmitted to relay station 120 and UEs.

At relay station 120, the downlink signal from base station 110 may be received and provided to a receiver (RCVR) 536. Receiver 536 may condition (e.g., filter, amplify, downconvert, and digitize) the received signal and provide input samples. A receive (RX) data processor 538 may process the input samples (e.g., for OFDM, etc.) to obtain received symbols. Processor 538 may further process (e.g., demodulate and decode) the received symbols to recover control information and data sent to UE 130. A TX data processor 530 may process (e.g., encode and modulate) the recovered data and control information from processor 538 in the same manner as base station 110 to obtain data symbols and control symbols. Processor 530 may also generate reference symbols, multiplex the data and control symbols with the reference symbols, and process the multiplexed symbol to obtain output samples. A transmitter 532 may condition the output samples and generate a downlink relay signal, which may be transmitted to UE 130.

At UE 130, the downlink signal from base station 110 and the downlink relay signal from relay station 120 may be received and conditioned by a receiver 552, and processed by an RX data processor 554 to recover the control information and data sent to UE 130. A controller/processor 560 may generate ACK information for correctly decoded packets. Data and control information (e.g., ACK information) to be sent on the uplink may be processed by a TX data processor 556 and conditioned by a transmitter 558 to generate an uplink signal, which may be transmitted to relay station 120.

At relay station 120, the uplink signal from UE 130 may be received and conditioned by receiver 536, and processed by RX data processor 538 to recover the data and control information sent by UE 130. The recovered data and control information may be processed by TX data processor 530 and conditioned by transmitter 532 to generate an uplink relay signal, which may be transmitted to base station 110. At base station 110, the uplink relay signal from relay station 120 may be received and conditioned by a receiver 516, and processed by an RX data processor 518 to recover the data and control information sent by UE 130 via relay station 120. A controller/processor 520 may control transmission of data based on the control information from UE 130.

Controllers/processors 520, 540 and 560 may direct operation at base station 110, relay station 120, and UE 130, respectively. Memories 522, 542 and 562 may store data and program codes for base station 110, relay 120, and UE 130, respectively.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprise a set of DL channels and UL channels.

The DL PHY channels comprises:
Common Pilot Channel (CPICH)
Synchronization Channel (SCH)
Common Control Channel (CCCH)
Shared DL Control Channel (SDCCH)
Multicast Control Channel (MCCH)
Shared UL Assignment Channel (SUACH)
Acknowledgement Channel (ACKCH)
DL Physical Shared Data Channel (DL-PSDCH)
UL Power Control Channel (UPCCH)
Paging Indicator Channel (PICH)
Load Indicator Channel (LICH)

The UL PHY Channels comprises:
Physical Random Access Channel (PRACH)
Channel Quality Indicator Channel (CQICH)
Acknowledgement Channel (ACKCH)
Antenna Subset Indicator Channel (ASICH)
Shared Request Channel (SREQCH)
UL Physical Shared Data Channel (UL-PSDCH)
Broadband Pilot Channel (BPICH)

In an aspect, a channel structure is provided that preservers low PAR (at any given time, the channel is contiguous or uniformly spaced in frequency) properties of a single carrier waveform.

For the purposes of the present document, the following abbreviations apply:
ACK Acknowledgement
AM Acknowledged Mode
AMD Acknowledged Mode Data
ARQ Automatic Repeat Request
BCCH Broadcast Control CHannel
BCH Broadcast CHannel
C- Control-
CCCH Common Control CHannel
CCH Control CHannel
CCTrCH Coded Composite Transport Channel
CP Cyclic Prefix
CQI Channel Quality Indication
CRC Cyclic Redundancy Check
CSG Closed Subscriber Group
CTCH Common Traffic CHannel
DCCH Dedicated Control CHannel
DCH Dedicated CHannel
DL DownLink
DSCH Downlink Shared CHannel
DTCH Dedicated Traffic CHannel
FACH Forward link Access CHannel
FDD Frequency Division Duplex
HARQ Hybrid Automatic Repeat Request
L1 Layer 1 (physical layer)
L2 Layer 2 (data link layer)
L3 Layer 3 (network layer)
LI Length Indicator
LSB Least Significant Bit
MAC Medium Access Control
MBMS Multimedia Broadcast Multicast Service
MBSFN multicast broadcast single frequency network
MCCHMBMS point-to-multipoint Control CHannel
MCE MBMS coordinating entity
MCH multicast channel
MCS Modulation Coding Scheme
MRW Move Receiving Window
MSB Most Significant Bit
MSCH MBMS point-to-multipoint Scheduling CHannel
MTCH MBMS point-to-multipoint Traffic Channel
MSCH MBMS control channel
NAK Negative Acknowledgement
PCCH Paging Control CHannel
PCH Paging Channel
PDCCH Physical Downlink Control Channel
PDSCH Physical Downlink Shared Channel
PDU Protocol Data Unit
PHICH Physical Indicator Signal Acknowledgement
PHY PHYsical layer
PhyCHPhysical Channels
PUSCH Physical Uplink Shared Channel
RACH Random Access CHannel
RLC Radio Link Control
RRC Radio Resource Control
SAP Service Access Point
SDU Service Data Unit
SF Subframe
SHCCH SHared channel Control CHannel
SN Sequence Number
SR Scheduling Request
SUFI SUper FIeld
TCH Traffic CHannel
TDD Time Division Duplex
TFI Transport Format Indicator
TM Transparent Mode
TMD Transparent Mode Data
TTI Transmission Time Interval
U- User-
UE User Equipment
UL UpLink
UM Unacknowledged Mode
UMD Unacknowledged Mode Data
UMTS Universal Mobile Telecommunications System
UTRA UMTS Terrestrial Radio Access
UTRAN UMTS Terrestrial Radio Access Network
VPLMN Visited Public Land Mobile Network

Embodiments described in detail herein set forth methods and apparatuses to apply Hybrid Automatic Repeat Request (HARQ) procedures for transparent relays through relay stations 120.

For example, a transparent relay may be defined as a relay through a relay station 120 in which there are no independent control channels established between the relay station 120 and the UE 130 that the relay station 120 is serving. Under this setup, the transparent relay station 120 does not have to transmit or receive control channels from the UE 130. Instead, the relay station 120 merely needs to maintain the control channel with the base station 110.

Unfortunately, a lack of control channels may lead to a broken Hybrid Automatic Repeat Request (HARQ) loop for LTE systems. Thus, it may be beneficial to provide methods and apparatuses to enable HARQ procedures for transparent relay stations 120 and associated UE(s) 130.

Systems, apparatuses, and methods are disclosed for a relay station 120 for use in a communication system with a base station 110 and user equipment (UE) 130. The relay station 120 may decode and forward a data packet between the base station 110 and the UE 130 that the relay station services in which the relay station does not establish a direct link with the UE 130. Further, the relay station 120 indicates successful decoding of the data packet to the base station 110 such that if the base station 120 receives information indicating successful decoding of the data packet from the relay station 120, the base station 110 terminates a HARQ transmission on a direct link between the base station 110 and the UE 130 such that HARQ retransmission time is extended compared to direct communications between the base station and the UE.

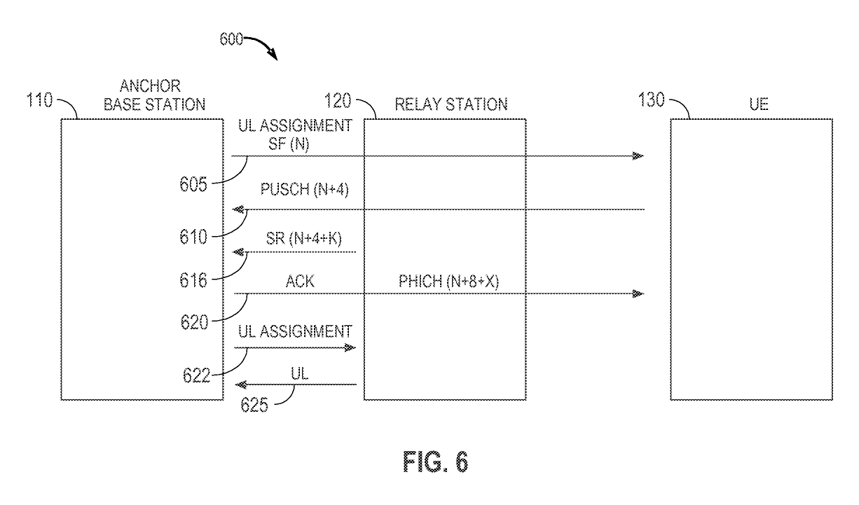

With reference to FIG. 6, a methodology 600 for applying HARQ procedures for transparent relays for a relay station 120 is illustrated.

In one embodiment, the anchor base station 110 may transmit an uplink (UL) assignment 605 to the UE 130. For example, in an exemplary LTE timeline, the UL assignment 605 may include a subframe (SF) index of N—SF(N). The UE 130 may then transmit data in a physical uplink shared channel (PUSCH) 610 to the anchor base station 110 at a later time, such as, PUSCH (N+4). It should be appreciated that the relay station 120 is sniffing the UL assignment 605 and the PUSCH data 610.

In the LTE system example, the LTE system may require that the anchor base station 110 transmit a physical indicator signal acknowledgement (PHICH) at N+8, in which 4 subframes are used for processing and scheduling. In the current embodiment, as an example, it may be assumed that a similar decoding latency is required for the relay station 120 to decode the UE transmission compared to that of the base station eNB 110.

Additional steps may next be implemented for the relay station 120 to exchange information with the anchor base station 110 in order to verify that the anchor base station 110 transmission is properly acknowledged. As an example, K milliseconds (ms) after decoding, relay station 120 may send a scheduling request (SR) 615 to the anchor base station 110 (denoted with time (N+4+K)). Then, L ms after SR transmission, anchor base station 110 may decode the relay station's SR.

For example, in order illustrate a physical indication signal acknowledgement (PHICH) timeframe, if x=K+L, then the anchor base station 110 PHICH timeline may be pushed out by x ms.

If the relay station 120 decodes the UE transmission (i.e., the PUSCH data 610) successfully, then, the relay station 120 may send the SR 615 to the anchor base station 110 at N+4+K to indicate that it has successfully decoded the UE transmission. The relay station 120 may then monitor the anchor base station 110 for the transmission of a physical indication signal acknowledgement (PHICH) and a physical downlink control channel (PDCCH) such that:
1. If the anchor base station 110 decodes the PUSCH data 610, the anchor base station 110 sends an Acknowledgement (ACK) as PHICH 620 and an assignment to UE 130 on a PDCCH at time (N+8+x). The assignment is intended for UE transmission at N+8+x+4. The relay station 120 may then decode both the PHICH and PDCCH and may turn on a UL Rx at N+8+x+4 such that the relay process begins again.
2. On the other hand, if the anchor base station 110 did not decode the PUSCH data 610, the anchor base station 110 sends an Acknowledgement (ACK) as PHICH 620 and an assignment on a PDCCH at time (N+8+x). However, the assignment is a UL assignment 622 and is intended for relay transmission at N+8+x+4. In this instance, the relay station 120 decodes the assignment, turns on a UL Tx at N+8+x+4, and transmits the decoded PUSH data (decoded by the relay station 120) via UL 625.
3. The relay station 120 may use the LTE system timeline when transmitting to the anchor base station 110 because there is no intermediate relay and the relay station 120 may transmit PUSCH data with independent coding. Also, the relay station 120 may transmit PUSCH data that consists of redundancy bits of the original codeword that the UE 130 transmitted to facilitate combining at the anchor base station 110. Also, it should be appreciated that, the anchor base station 110 may possibly schedule parallel UE(s) 130 and relay station(s) 120 transmissions which may lead to a conflict of relay station(s) transmit and receive functions. Therefore, if a relay station 120 transmits to an anchor base station 110 in order to assist the decoding of the previous PUSCH data, the modulation coding scheme (MCS) selection of the UE's new transmission should take into account the fact that the relay station 120 is tuned away. Further, if the relay station 120 receives the new PUSH data, the MCS selection of the UE's new transmission should take into account the fact that the relay station 120 is assisting the new packet decoding.

On the other hand, if the relay station 120 was not able to decode the UE transmission (i.e., the PUSCH data 610) successfully, then: the relay station 120 may transmit a negative acknowledgement (NAK) to the anchor base station 110 (or by an implicit NAK by not sending an SR); the anchor base station 110 may transmit an anchor NAK to the UE 130 (e.g. the anchor NAK may be over PHICH UE at N+8+x); and the anchor base station 110 may then re-transmit a UL assignment (e.g., at N+8+x+4) to the relay station 120.

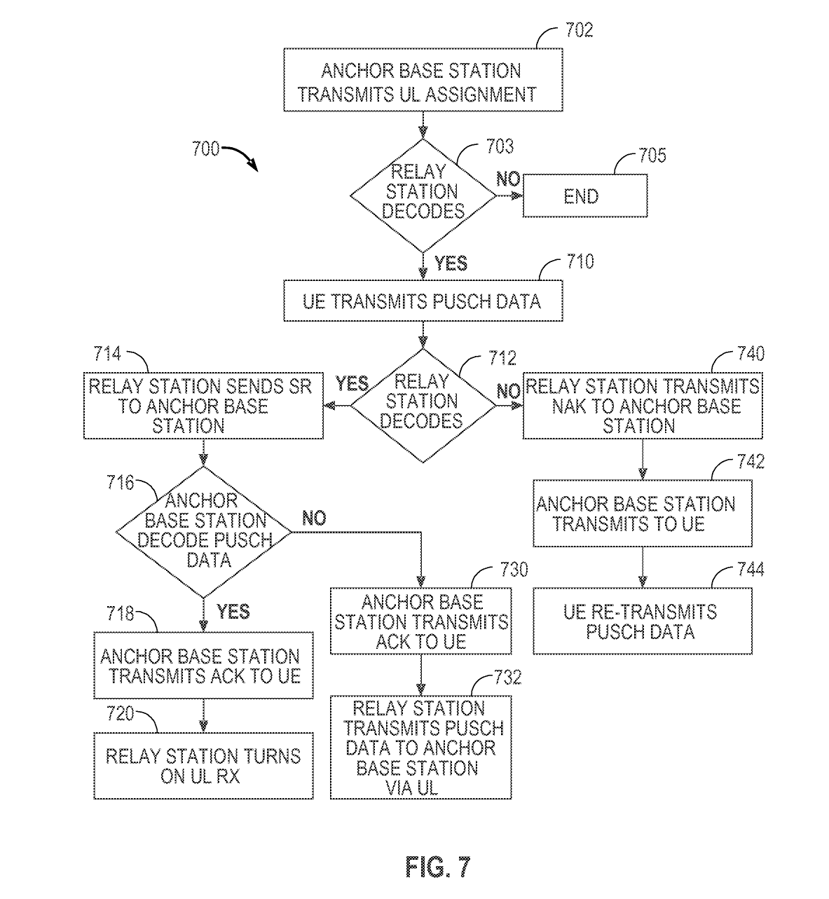

With reference to FIG. 7, FIG. 7 is a flowchart that illustrates a process 700 for applying HARQ procedures for transparent relays for a relay station 120. At block 702, the anchor base station 110 may transmit an uplink (UL) assignment for the UE 130. At decision block 703, process 700 determines whether the relay station 120 successfully decoded the UL assignment. If not, process 700 ends (block 705). However, if so, and the UE transmits PUSCH data (block 710) to the anchor base station, process 700 next determines if the relay station 120 decoded the PUSCH data (block 712). If so, the relay station 120 sends an SR to the anchor base station 110 (block 714). Next, process 700 determines if the anchor base station 110 decoded the PUSH data (block 716). If so, the anchor base station 110 transmits an ACK to the UE 130 (block 718) and the relay station 120 turns on UL Rx (block 720). If not, the anchor base station transmits an ACK to the UE 130 (block 730) and the relay station 120 transmits the decoded PUSCH data to the anchor base station 110 via a UL (block 732). On the other hand, if the relay station 120 was not able to decode the PUSCH data (block 712), then: the relay station 120 transmits a NAK to the anchor base station 110 (block 740), the anchor base station 110 transmits a NAK to the UE (block 742), and the UE 130 re-transmits PUSCH data (block 744).

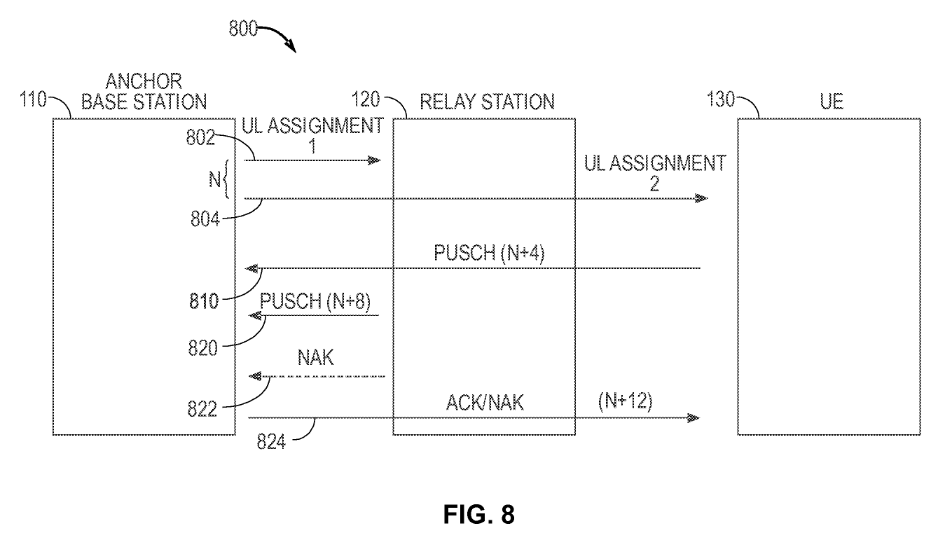

With reference to FIG. 8, in another embodiment, for each UL transmission, the anchor base station 110 may schedule two transmissions, one for the UE 130 and another for the relay station 120. For example, the anchor base station 110 may send a first UL assignment 802 to the relay station 120 and may send a second UL assignment 804 to the UE 130. For example both UL assignments 802 and 804 may be at SF index N. UE 130 may then transmit PUSCH data 810 at N+4. If the relay station 120 decodes the PUSCH data, then the relay station 120 may transmit the PUSCH data 820 at N+8. However, if the relay station does not decode the PUSCH data, relay station 120 may either be: A) silent; or B) send a NAK 822 to the anchor base station 110 to indicate a PUSCH decoding failure. For example, the NAK may be a new UL control channel. The anchor base station 110 may combine both the transmissions of PUSCH data from the UE 130 and the relay station 120. Further, the anchor base station 100 may transmit an ACK or a NAK 824 on PHICH (e.g., at SF index N+12) to acknowledge or not acknowledge receipt of the PUSCH data from the UE.

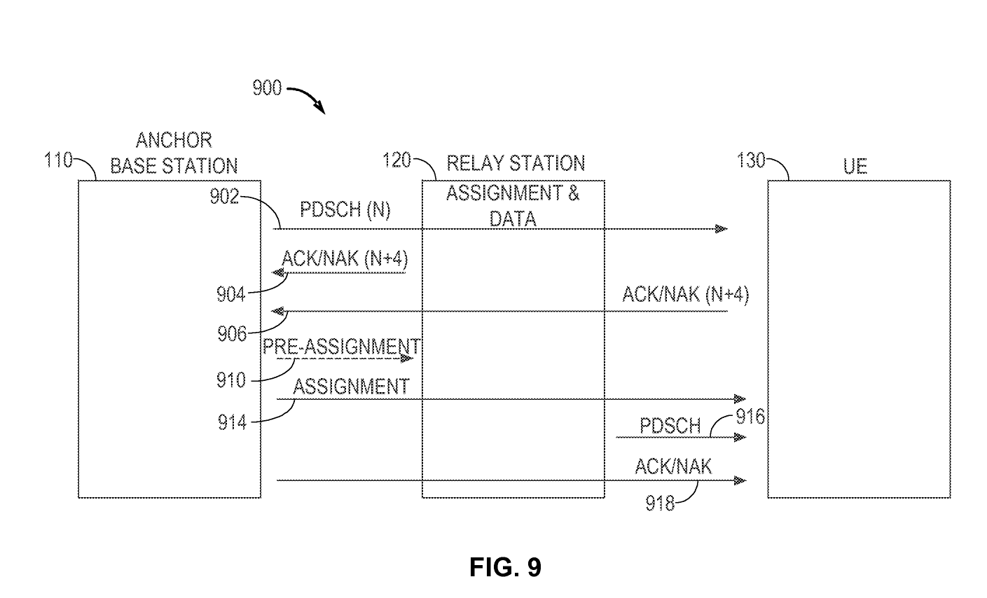

With reference to FIG. 9, a methodology 900 for applying asynchronous HARQ procedures for a downlink (DL) is illustrated. In this embodiment, for an LTE downlink (DL) assignment, the HARQ may be asynchronous, such that each individual re-transmission may be setup without coupling. This may allow for the separate scheduling of the anchor base station 110 to the UE 130 and the relay station 120 to UE 130 transmissions.

Looking at FIG. 9, the anchor base station 110 may transmit a physical downlink shared channel (PDSCH) 902 (e.g., at index N) to transmit a DL assignment and data to UE 130, which relay station 120 also sniffs. Based upon this, the anchor base station 100 may receive an ACK or NAK 904 from the relay station 120 and an ACK or NAK 906 from UE 130 (e.g., at N+4). The anchor base station 110 may then transmit a pre-assignment 910 (e.g., at N+8) to inform the relay station 120 of a scheduling decision of relay station 120 to UE 130 transmission. However, as will be discussed this pre-assignment 910 is an optional embodiment. Next, base station 110 transmits a DL assignment 914 to UE 130 and relay station 120 transmits a PDSCH 916 including data to the UE 130 (e.g., at N+12). The UE 130 may then transmit an ACK or NAK 918 back to the anchor base station 110. It should be appreciated that the system 900 may loop between pre-assignment 910, assignment 914, PDSCH 916, and ACK/NAK 918 until the UE decodes the data.

However, in one embodiment, in order to improve latency, relay station 120 to UE 130 transmission (e.g., PDSCH 916) may be pre-scheduled by the anchor base station 110. In this case, pre-assignment 910 may be skipped to reduce latency. In this example, DL assignment 914 to UE 130 and relay station 120 transmission of PDSCH 916 including data to UE 130 may occur at N+8. This is a trade-off of the latency/control overhead and data efficiency. Additionally, if the relay station 120 is able to receive ACK/NAK from the UE 130, latency may also be reduced by using synchronous HARQ between the relay station 120 and the UE 130. Trade-offs between latency, control overhead, and data efficiency may be considered as design and implementation considerations.

Other aspects for relay retransmission with a pre-scheduled transmission format may also be considered. For example, in one embodiment, this format may be conditioned based upon on the UE 130. Additionally, the pre-configured transmission format may be based on a UE channel quality indication (CQI) report. Further, the pre-configured transmission format may be based on the original DL transmission format. Moreover, the pre-configured transmission format may be a form of the asynchronous HARQ re-transmission of the original transmission. For example, utilizing modulation coding schemes (MCS): the MCS could be the same; or the MCS could be changed, for example, given the same dimension, such as: 1) If the backhaul link>access link, the MCS chosen for the first transmission could be higher than the relay station 120 to UE 130 transmission; 2) If the backhaul link<access link, the MCS chosen for the first transmission could be lower than the relay station 120 to UE 130 transmission; or 3) If dimension changes, the MCS may be adjusted accordingly. In another embodiment, the resource elements used in the relay station 120 to UE 130 transmission may be fixed or may be a function of the original DL assignment. For example, illustrative embodiments include: same size+same location, same size+different time-frequency location, different size+same location, different size+different location.

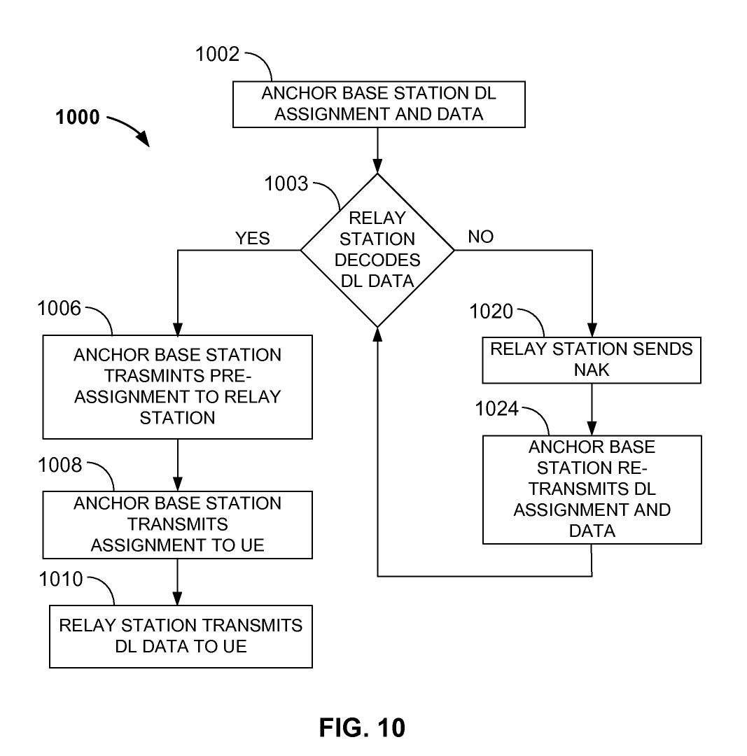

With reference to FIG. 10, FIG. 10 is a flowchart that illustrates a process 1000 for applying HARQ procedures for transparent relays for a relay station 120 for an associated UE 130. At block 1002, the anchor base station 110 may transmit a downlink (DL) assignment and data to the UE 130 that the relay station 120 sniffs. At decision block 1003, process 1000 determines whether the relay station 120 successfully decoded the DL data. If so, the anchor base station 110 transmits a pre-assignment to the relay station 120 (block 1006). Next, the anchor base station 110 transmits an assignment to the UE (block 1008). The relay station 120 then transmits the decoded DL data to the UE 130 (block 1010).

On the other hand, if at decision block 1003, process 1000 determines that the relay station 120 did not successfully decode the DL data, then the relay station 120 sends a NAK to the anchor base station 110 (block 1020). The anchor base station 110 may then re-transmit a DL assignment and data to the UE 130 (block 1024) and re-start process 1100.

It should be appreciated that controllers/processors 520, 540 and 560 of FIG. 5 may direct operation at base station 110, relay station 120, and UE 130, respectively, and that the controllers/processors 520, 540 and 560 may perform or direct the processes and methodologies 600, 700, 800, 900, and 1000 of FIGS. 6-10 and/or other processes for the techniques described herein. Memories 522, 542 and 562 may store data and program codes for base station 110, relay 120, and UE 130, respectively.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An apparatus comprising:
a processor configured to execute instructions to:
decode and forward a data packet between a base station and a user equipment (UE) serviced by a relay station, wherein the relay station does not establish a direct link with the UE; and
indicate successful decoding of the data packet to the base station, wherein, if the base station receives information indicating successful decoding of the data packet from the relay station, the base station terminates a hybrid automatic repeat request (HARQ) transmission on a direct link between the base station and the UE such that HARQ retransmission time is extended as compared to direct communications between the base station and the UE; and
a memory configured to store the instructions.

2. The apparatus of claim 1, further comprising transmitting an acknowledgement (ACK) from the base station to the UE.

3. The apparatus of claim 1, further comprising determining if the base station decoded the data packet.

4. The apparatus of claim 3, wherein if the base station did not decode the data packet, further comprising transmitting the decoded data packet to the base station.

5. The apparatus of claim 1, wherein, if the relay station did not decode the data packet, further comprising transmitting a negative acknowledgement (NAK) from the relay station to the base station.

6. The apparatus of claim 5, wherein, if the relay station did not decode the data packet, further comprising transmitting a negative acknowledgement (NAK) from the base station to the UE and re-transmission of the data packet by the UE.

7. A method comprising:
decoding and forwarding a data packet between a base station and a user equipment (UE) serviced by a relay station, wherein the relay station does not establish a direct link with the UE; and
indicating successful decoding of the data packet to the base station, wherein, if the base station receives information indicating successful decoding of the data packet from the relay station, the base station terminates a hybrid automatic repeat request (HARQ) transmission on a direct link between the base station and the UE such that HARQ retransmission time is extended as compared to direct communications between the base station and the UE.

8. The method of claim 7, further comprising transmitting an acknowledgement (ACK) from the base station to the UE.

9. The method of claim 7, further comprising determining if the base station decoded the data packet.

10. The method of claim 9, wherein if the base station did not decode the data packet, further comprising transmitting the decoded data packet to the base station.

11. The method of claim 7, wherein, if the relay station did not decode the data packet, further comprising transmitting a negative acknowledgement (NAK) from the relay station to the base station.

12. The method of claim 11, wherein, if the relay station did not decode the data packet, further comprising transmitting a negative acknowledgement (NAK) from the base station to the UE and re-transmission of the data packet by the UE.

13. A computer program product, comprising:
a computer-readable medium comprising code for causing at least one computer to:
decode and forward a data packet between a base station and a user equipment (UE) serviced by a relay station, wherein the relay station does not establish a direct link with the UE; and
indicate successful decoding of the data packet to the base station, wherein, if the base station receives information indicating successful decoding of the data packet from the relay station, the base station terminates a hybrid automatic repeat request (HARQ) transmission on a direct link between the base station and the UE such that HARQ retransmission time is extended as compared to direct communications between the base station and the UE.

14. The computer program product of claim 13, further comprising code for causing at least one computer to transmit an acknowledgement (ACK) from the base station to the UE.

15. The computer program product of claim 13, further comprising code for causing at least one computer to determine if the base station decoded the data packet.

16. The computer program product of claim 15, wherein if the base station did not decode the data packet, further comprising code for causing at least one computer to transmit the decoded data packet to the base station.

17. The computer program product of claim 13, wherein, if the relay station did not decode the data packet, further comprising code for causing at least one computer to transmit a negative acknowledgement (NAK) from the relay station to the base station.

18. The computer program product of claim 17, wherein, if the relay station did not decode the data packet, further comprising code for causing at least one computer to transmit a negative acknowledgement (NAK) from the base station to the UE and retransmission of the data packet by the UE.

19. An apparatus comprising:
means for decoding and forwarding a data packet between a base station and a user equipment (UE) serviced by a relay station, wherein the relay station does not establish a direct link with the UE; and
means for indicating successful decoding of the data packet to the base station, wherein, if the base station receives information indicating successful decoding of the data packet from the relay station, the base station terminates a hybrid automatic repeat request (HARQ) transmission on a direct link between the base station and the UE such that HARQ retransmission time is extended as compared to direct communications between the base station and the UE.

20. The apparatus of claim 19, further comprising means for transmitting an acknowledgement (ACK) from the base station to the UE.

21. The apparatus of claim 19, further comprising means for determining if the base station decoded the data packet.

22. The apparatus of claim 21, wherein if the base station did not decode the data packet, further comprising means for transmitting the decoded data packet to the base station.

23. The apparatus of claim 19, wherein, if the relay station did not decode the data packet, further comprising means for transmitting a negative acknowledgement (NAK) from the relay station to the base station.

24. The apparatus of claim 23, wherein, if the relay station did not decode the data packet, further comprising means for transmitting a negative acknowledgement (NAK) from the base station to the UE and retransmission of the data packet by the UE.

25. A wireless communications method, comprising:
transmitting downlink (DL) assignment and data from a base station to user equipment (UE); and
determining if the DL data is decoded by a relay station.

26. The method of claim 25, wherein, if the DL data is decoded by the relay station, further comprising transmitting a pre-assignment from the base station to the relay station.

27. The method of claim 26, further comprising transmitting the decoded DL data from the relay station to the UE.

28. The method of claim 25, wherein if the DL data is not decoded by the relay station, further comprising transmitting a not acknowledged (NAK) signal from the relay station to the base station.

29. The method of claim 28, further comprising re-transmitting the DL assignment and data from the base station to the UE.

30. A relay station for use in a communication system with a base station and user equipment (UE), comprising:
a processor configured to execute instructions to:
decode downlink (DL) data transmitted from the base station to the UE; and
a memory configured to store the instructions.

31. The relay station of claim 30, wherein, if the DL data is decoded by the relay station, receiving a pre-assignment from the base station.

32. The relay station of claim 31, further comprising transmitting the decoded DL data to the UE.

33. The relay station of claim 30, wherein, if the DL data is not decoded by the relay station, further comprising transmitting a not acknowledged (NAK) signal to the base station.

34. The relay station of claim 33, wherein the base station re-transmits the DL assignment and data to the UE.

35. An apparatus comprising means for decoding downlink (DL) data transmitted from a base station to user equipment (UE).

36. The apparatus of claim 35, wherein, if the DL data is decoded by a relay station, further comprising means for receiving a pre-assignment from the base station.

37. The apparatus of claim 36, further comprising means for transmitting the decoded DL data to the UE.

38. The apparatus of claim 35, wherein, if the DL data is not decoded by a relay station, further comprising means for transmitting a not acknowledged (NAK) signal to the base station.

39. The apparatus of claim 38, wherein the base station re-transmits the DL assignment and data to the UE.

40. A computer program product, comprising:
a computer-readable medium comprising code for causing at least one computer to decode downlink (DL) data transmitted from a base station to user equipment (UE).

41. The computer program product of claim 40, wherein, if the DL data is decoded by the relay station, further comprising code for causing at least one computer to receive a pre-assignment from the base station.

42. The computer program product of claim 41, further comprising code for causing at least one computer to transmit the decoded DL data to the UE.

43. The computer program product of claim 40, wherein, if the DL data is not decoded by the relay station, further comprising code for causing at least one computer to transmit a not acknowledged (NAK) signal to the base station.

44. The computer program product of claim 43, wherein the base station re-transmits the DL assignment and data to the UE.
